(19) United States
(12) Patent Application Publication
(10) Pub. No.: US 2026/0145185 A1
(43) Pub. Date: May 28, 2026

(54) NOZZLE WITH A FIRST PASSAGE AND SECOND PASSAGES SURROUNDING THE FIRST PASSAGE AND NOZZLE ARRANGEMENT

(71) Applicant: ESTA APPARATEBAU GMBH & CO. KG, Senden (DE)

(72) Inventors: Michael NOVOSEL, Nattheim (DE); Maik HERRMANN, Elchingen (DE); Johann Paul HAHN, Dietenheim (DE)

(73) Assignee: ESTA APPARATEBAU GMBH & CO. KG, Senden (DE)

(21) Appl. No.: 19/120,597

(22) PCT Filed: Oct. 12, 2023
(86) PCT No.: PCT/EP2023/078338

§ 371 Date: Apr. 11, 2025

(30) Foreign Application Priority Data
Oct. 14, 2022 (DE) 10 2022 126 941.8
Oct. 14, 2022 (EP) 22201608.1

(51) Int. Cl. B05B 1/14; B01D 46/69; B05B 15/658

(52) U.S. Cl. CPC B05B 1/1423; B01D 46/69; B05B 15/658

(57) ABSTRACT

A nozzle includes a first nozzle section configured as a truncated cone, a first passage that forms a first nozzle opening in a top surface of the first nozzle section, and second passages forming second nozzle openings in the lateral surface of the first nozzle section. The second passages each have a passage axis tilted with respect to a parallel axis which extends parallel to the center axis of the nozzle. A nozzle assembly includes a feed line, a feed line opening, at least one nozzle comprising an inlet opening, and at least one nozzle holder comprising a receptacle. The nozzle defines a recess for abutment against the feed line, and the nozzle is releasably held and centered at the receptacle. The nozzle holder is held in a releasable manner at the feed line.

### TECHNICAL FIELD

The present invention relates to a nozzle for cleaning a filter element by means of a fluid flow, comprising a first passage and second passages surrounding the first passage. The present invention further relates to a nozzle assembly comprising a pipe and a nozzle attached to it.

### BACKGROUND OF THE INVENTION

Nozzles with a wide variety of geometries and for a wide variety of purposes are already known from the prior art, in particular as air nozzles or liquid nozzles.

When cleaning filter elements, such as cartridge filters, pocket filters, flat filters or cylindrical filters, a directed fluid flow is used to remove a filter cake from the filter element. For example, cleaning is carried out by backflow, as known, for example, from DE 44 23 439 A1. However, cleaning can also be carried out by directing the fluid transversely to a surface of the filter element on which the filter cake settles along this surface in order to shear off the filter cake. Cleaning a filter by means of an air flow is also known, for example, from DE 20 2013 100 593 U1.

In the cleaning methods mentioned, in particular for cylindrical filter elements, in which the fluid flow is directed transversely to an inner lateral surface and in the direction of the center axis of the cylindrical filter element, nozzles are used to generate or guide a specific fluid flow. For example, air blasts are released from a compressed air tank or a compressed air line by means of solenoid valves and directed onto the filter element through the nozzle. A disadvantage of this method is that the flow is often not directed evenly enough over the surface to be cleaned and/or with insufficient momentum to clean the entire surface. In particular, a sufficient momentum or a sufficient shearing effect can no longer be achieved beyond a certain distance from the nozzle.

Furthermore, known nozzles are often fixedly mounted in a corresponding nozzle assembly and then difficult to remove from the supply line or from the nozzle assembly, for example for maintenance or replacement.

From WO 2017/059405 A1, a nozzle for discharging liquids such as suspensions, for example for coating applications, is known which aims to create a uniform particle distribution in a spray cone.

Furthermore, a nozzle with a central opening for discharging a liquid, in particular a fuel, for example by means of a mouthpiece passed through the opening, is known from DE 603 18 287 T2.

US 2004/0124283 A1 further discloses a branching piece for fluid conveying pipes. The branching piece has a channel which is provided with an inlet which can be connected to a vent opening formed in a pipe for conveying a fluid. The branching piece further comprises an outlet connectable to at least one nozzle and a tubular body, the body being provided with a first end detachably connectable to the inlet and with a second end, the second end being detachably insertable so as to fit snugly into the vent opening.

### DESCRIPTION OF THE INVENTION

Based on this situation, it is an object of the present invention to propose a nozzle or nozzle assembly by means of which the fluid flow during cleaning of a filter element, in particular by fluid flow transverse to a surface of the filter element, can be improved and which is easy to handle.

The object of the invention is achieved by the features of the independent main claims. Advantageous embodiments are provided in the subclaims. If technically possible, the teachings of the subclaims can be combined arbitrarily with the teachings of the main and subclaims.

Advantages of the claimed aspects of the invention are explained below and, further below, preferred modified embodiments of the aspects of the invention are described. Explanations, in particular regarding advantages and definitions of features, are essentially descriptive and preferred, but not limiting, examples. If an explanation is limiting, this is explicitly mentioned.

Insofar as elements are designated by means of numbering, for example “first element”, “second element” and “third element”, this numbering is intended purely for differentiation in the designation and does not represent any interdependency of the elements or a mandatory sequence of the elements. This means, in particular, that a device or a process, for example, does not have to comprise a “first element” in order to be able to comprise a “second element”. The device or process can also comprise a “first element” and a “third element” without necessarily comprising a “second element”. It is also possible to provide several units of an element of a single numbering, for example several “first elements”.

According to a first aspect of the invention, the object is achieved by a nozzle for cleaning a filter element by means of a fluid flow, comprising at least one first nozzle section designed as a hollow truncated cone, at least one first passage, wherein the first passage forms a first nozzle opening in a top surface of the first nozzle section, and a plurality of second passages surrounding the first passage, wherein the second passages form second nozzle openings in the lateral surface of the first nozzle section, wherein the second passages each comprise passage axis tilted with respect to a parallel axis which extends parallel to a center axis of the nozzle in order to impart a helical flow contour to the fluid flow.

A nozzle is understood to be a device with an inlet side or an inlet cross-section and an outlet side or an outlet cross-section, wherein a fluid flows into the nozzle at the inlet side or through the inlet cross-section and out of the nozzle at the outlet side or through the outlet cross-section. In this context, the fluid flow between the inlet side/inlet cross-section and the outlet side/outlet cross-section, and in particular by means of nozzle openings that form the outlet side or the outlet cross-section, is influenced with regard to its flow properties. In particular, the fluid flow is influenced with respect to the flow contour, the flow velocity and the mass flow. The flow contour is understood to be the sum of the trajectories of the spatial positions and velocities through which the individual fluid particles pass. A fluid is in particular air, another gas or a liquid such as water.

A filter element is, for example, designed as a cylindrical filter element, as a pocket filter, as a cartridge filter or as a flat filter and comprises a filter medium such as a fleece or the like that is permeable to one part of a fluid flow to be filtered and impermeable to another part of the fluid flow to be filtered. For example, dusts and particles are filtered out of an air flow in this way. The retained parts of the fluid flow to be filtered form a filter cake on and/or in the filter medium at a front side of the filter medium over time or with the amount of fluid that has flowed through the filter medium, thereby increasing the flow resistance for the fluid. Cleaning involves at least partially removing the filter cake from the surface of the filter medium in order to reduce the flow resistance (again).

A hollow truncated cone is understood to mean a geometry that forms a coaxial connecting surface between a round base surface and a round cap that is smaller than the base surface. Here, due to the hollow design an inner space is formed at the truncated cone that geometrically corresponds to the outer contour, wherein the inner space is free of material. The truncated cone thus forms a wall that forms the lateral surface of the outer contour and the lateral surface of the inner contour. In particular, the inner space forms an inlet opening of the truncated cone at the base surface for entry of a fluid flow.

A passage is understood to be a recess through a material, in particular a wall or several walls, wherein the walls are in particular designed to be parallel to one another and in particular parallel to a passage axis. A passage can also become larger or smaller in cross-section along the passage axis, so that the walls are then, for example, not exactly parallel to one another, but almost parallel, for example. A passage is defined in particular by a direction of the passage axis and a passage geometry. Any passage geometries are possible, in particular with regard to the cross-section, but a passage is preferably designed as a hole with a round cross-section and a hole diameter.

A helical shape of the flow contour is determined by the fact that individual fluid particles follow a helical trajectory. In this respect, a twist is imparted to the flow contour or to individual fluid particles.

The solution to the object described above thus includes the technical teaching that a first nozzle opening is provided centrally at the top surface for discharging a core flow and that a plurality of second nozzle openings are provided around the first nozzle opening at the lateral surface for discharging an outer flow. In this case, the first nozzle opening or the first passage provided to form the first nozzle opening is preferably arranged concentrically with the center axis of the nozzle, i.e. it has a passage axis concentric with the center axis and walls parallel to the center axis. The flow direction of the core flow thus points straight out of the nozzle. Meanwhile, the second passages are each tilted so that the outer flow has an imparted twist or an imparted flow direction towards the helical shape. The core flow, which without the outer flow would already fan out comparatively close behind the nozzle in a funnel shape and would thus only act on the surface of the filter element with greatly reduced momentum, can be constricted or bundled and thus directed by the helical outer flow. The outer flow is prevented from fanning out by imparting the helical flow contour, and the outer flow acts on the entire flow contour in such a way that the flow contour as a whole is constricted/bundled and stabilized in space. A flow contour stabilized in this way can then act in a more targeted manner, in particular at an increased distance from the nozzle at the surface of the filter element, and apply an increased momentum component to a desired area of the surface. In particular, it is possible, by means of the precise geometric design of the nozzle, in particular by means of the diameter ratio of the first passage to the second passage, by means of the number and arrangement of the second passages and by means of the selection of tilt angles, about which the second passages are respectively tilted with respect to the parallel axes, to adapt the flow contour precisely to specific filter elements, in particular with respect to their diameter or the development of the diameter over the axial distance from the nozzle. The flow contour then precisely fills a cylindrical filter element, for example, and a particularly favorable shear is achieved at the inner surface of the cylindrical filter element. In simplified terms, tilting the second passages enables a particularly stable flow contour and a simple and precise control over the directional characteristic of the nozzle, so that the directional characteristic can be precisely selected for a specific application.

In one embodiment, the second passages are arranged on a circular path concentric with the center axis of the nozzle. The flow contour is then advantageously axially symmetrical about the center axis of the nozzle or about a core flow aligned concentrically thereto and is thus particularly stable.

In addition, such a flow contour is particularly suitable for cleaning a cylindrical filter element. Such a cylindrical shape is a standard geometry for filter elements when filtering air flows in industrial applications. Furthermore, an advantageous feature of the arrangement of the second passages on a circular path concentric with the center axis at the nozzle, whose base body formed at least by the first nozzle section is round in cross-section, is that a uniform pressure distribution within the nozzle is created, so that the material load of the nozzle is kept low.

In one embodiment, the first nozzle section comprises a concavely tapering lateral surface. A concave tapering of the lateral surface or of the truncated cone is understood to mean that the lateral surface is designed to be strongly tapered not linearly but in a concave manner in a decreasing manner in the axial direction of the truncated cone from the base surface to the top surface. In this respect, a geometry is also understood to be a truncated cone whose lateral surface has a concavity (and/or convexity) of the lateral surface compared to a geometrically ideal truncated cone. Advantageously the concave taper elongates the second nozzle passages, so that their cross-section is increased and the proportion of the outer flow to the total flow contour compared to a linearly tapering surface is increased.

In a further embodiment, the nozzle comprises a second nozzle section that is connected to a base surface of the first nozzle section and is designed as a hollow cylinder. The nozzle is then extended towards its inlet side and comprises an inner area in the second nozzle section, within which the fluid flow can adjust and stabilize in a laminar manner independently of upstream components before the fluid reaches the nozzle openings. In this way, a stable and uniform or axisymmetric flow is enabled.

In a preferred Implementation of the aforementioned embodiment, the second passages extend radially outwards from the inside into an outer wall of the second nozzle section to form a contour at an inner side of the outer wall. The second passages thus overlap with the wall of the second nozzle section, without, however, intersecting its outer contour. Thus, groove-shaped recesses are formed at the inside of the wall of the second nozzle section. Advantageously a twist or a helical flow contour is imparted already within the nozzle, namely in the second nozzle section, comparable to imparting a twist to a projectile in a rifle by rifling arranged in the rifle barrel. In this way, the flow contour is further stabilized.

Particularly preferably, in the case of the above-described embodiment, the second nozzle section comprises a recess at a base surface for abutment against a cylindrical contour extending at an angle to the center axis of the nozzle and in particular a collar. The second nozzle section can then be placed, for example, in a contour-fitting manner at an opening in a side wall of a tubular feed line, so that a particularly flow-favorable and interruption-free, in particular tight, transition is formed between the feed line and the nozzle. In this case, the nozzle can be positioned with its center axis perpendicular or at any other angle on the feed line. By forming a collar, a contact surface of the nozzle at the supply line is increased, for example, for the provision of sealing means. However, particularly preferably, such a collar can also be used to hold the nozzle at the feed line, in particular for holding in a form-fitting manner. The collar is preferably designed along the recess for abutting against the cylinder contour or forms the contour itself.

In one embodiment, the passage axes of the second passages are each tilted about a first transverse axis, which is perpendicular to the parallel axis and intersects the center axis of the nozzle, by a first tilt angle. Preferably, the first tilt angle is 0 to 45°, particularly preferably 23°. For example, the first tilt angle is 1°, 2°, 3°, 5°, 10°, 15°, 20°, 23°, 25°, 30°, 35°, 40°, 45° or an angle lying between these values. The provision of the first tilt angle particularly influences the pitch of the helical contour of the outer flow. The selected first tilt angle preferably achieves a favorable constriction of the flow contour and a favorable range of the flow contour, that is, a sufficient distance from the nozzle at which the flow contour is still stable.

In a further embodiment, the passage axes of the second passages are each tilted about a second transverse axis, which is perpendicular to the parallel axis and perpendicular to the first transverse axis, by a second tilt angle. Preferably, the second tilt angle is 0 to 90°, particularly preferably 45°. The second tilt angle is, for example, 1°, 2°, 3°, 5°, 10°, 15°, 20°, 25°, 30°, 35°, 40°, 45°, 50°, 55°, 60°, 65°, 70°, 75°, 80°, 85°, 90° or an angle lying between these values. The selected second tilt angle influences the diameter or the development of the diameter over the axial distance from the nozzle of the flow contour. The nozzle can advantageously be adjusted in the selected range of the second tilt angle for cleaning the inner surface in the axial direction of a plurality of cylindrical filter elements, in particular for a plurality of length-to-diameter ratios of such cylindrical filter elements.

Preferably, a tapering ratio between an inlet cross-section and an outlet cross-section of the nozzle is between 1:1 and 3:1. An inlet cross-section is formed in particular by an inlet opening formed by the interior at the base surface of the first nozzle section or the second nozzle section. An outlet cross section is obtained as the sum of the cross sections of all nozzle openings. At the ratios mentioned, a favorable ratio between the flow velocity and the mass flow of the air flow is achieved for cleaning filter elements by means of air blasts from a pressure tank or a pressure line.

In one embodiment, the first passage is formed round and has a diameter of 1 to 70% of a nozzle diameter. The nozzle diameter is understood to be the maximum outer diameter of the nozzle. In a further embodiment, preferably combined with this embodiment, the second passages are also each formed round and have a diameter of 1 to 70% of the nozzle diameter. With the above-mentioned diameters, a favorable flow contour is achieved for cleaning conventional cylindrical filter elements for air cleaning in industrial applications. In addition, a favorable ratio of the core flow to the outer flow is then present for a stable flow contour with a favorable range.

Preferably, an odd number of second passages is provided. This avoids point symmetries, which can be accompanied by mutually canceling effects.

In a further embodiment, the nozzle comprises a plurality of third passages, each intersecting an inner contour of the first passages and extending parallel to the central axis of the nozzle. The third passages act as a contouring of the first passage, whereby the core flow already undergoes a bundling and direction in itself. Advantageously, a particularly well-directed and stable flow contour is achieved.

A nozzle according to the aspect of the invention described above is preferably produced by means of an additive manufacturing process. This has the advantage that a selection of one or more tilt angles can be set specifically for cleaning a particular filter element and produced with little effort.

In particular, additive manufacturing enables complex geometries of the nozzle with low production costs.

The object is also achieved by a nozzle assembly for cleaning a filter element by means of a fluid flow, comprising a tubular feed line comprising a feed line opening in a lateral surface of the feed line, at least one nozzle designed as a hollow body with a base surface, wherein the nozzle comprises an inlet opening in the base surface, and at least one nozzle holder comprising a receptacle for the nozzle, wherein the nozzle comprises a recess at the base surface for abutment against the lateral surface of the feed line, such that the inlet opening abuts against the feed line and is aligned with the feed line opening, and wherein the nozzle is releasably held and centered at the receptacle of the nozzle holder and the nozzle holder is releasably held at the feed line. The feed line is connected, for example, to a pressure tank or a pressure line.

A tubular geometry is understood to be a geometry that extends mainly in a longitudinal direction as a profile. The profile is formed as any hollow profile and is, for example, formed round or polygonal. A cross-section of the profile can be constant or variable over the longitudinal extension.

With regard to the nozzle, the terms used in the above description of the nozzle assembly are to be understood as they are understood with regard to the nozzle described above.

The solution to the object described above thus includes the teaching that a nozzle is held at the feed line by means of a nozzle holder, wherein both the nozzle and the nozzle holder are held at the feed line in a releasable manner. The nozzle holder is designed in such a way that the nozzle is centered with respect to the nozzle holder and with respect to the feed line. For example, correspondingly shaped centering means are provided on the nozzle and the nozzle holder for this purpose. Thus, by means of the centering an alignment of the inlet opening of the nozzle with the feed line opening is achieved. By means of the nozzle assembly it is also advantageously enabled to arrange a nozzle at the feed line with little effort and with few tools. In this way, the nozzle assembly can be easily disassembled and then reassembled to change a nozzle for maintenance, to change a nozzle geometry or for cleaning. The nozzle assembly is also designed to be simple and inexpensive to manufacture. The nozzle assembly described above also allows the nozzle to be positioned freely at the pipe, depending on the positioning of a feed line opening.

Due to the design of the nozzle assembly as described above, the nozzle is held securely in all spatial directions at the nozzle holder or at the feed line, and in particular is held in a torsion-proof manner. This prevents the nozzle from slipping and/or twisting during operation of the nozzle assembly.

The feed line opening is preferably aligned transversely, in particular exactly perpendicular to a center axis of the feed line, or is oriented at an angle away from this center axis of the feed line. The recess arranged at the base surface of the nozzle is oriented at a corresponding angle for abutment against the lateral surface of the feed line.

In a particularly preferred embodiment of the invention, the nozzle of the nozzle assembly is designed in accordance with the solution of the object with a nozzle as described above. The advantages described in this regard are then achieved accordingly for the nozzle assembly. In particular, such a nozzle can then be positioned at the feed line in such a way that the flow contour is precisely positioned with respect to the filter element for cleaning the surface of the filter element.

In a further preferred embodiment, the nozzle is held in a form-fitting manner at the nozzle holder and, in particular, can be inserted into the recess from an inner side of the nozzle holder that is covered by the feed line. The form-fitting holding makes it particularly easy to attach and center the nozzle at the nozzle holder. In this case, the form fit is particularly preferably designed in such a way that the nozzle occupies a centered position therein. By means of a design in which the nozzle can be inserted into the recess from an inside of the nozzle holder that is covered by the feed line, the nozzle can be easily fixed in the receptacle by means of the feed line in order to achieve centering and securing. When the nozzle assembly is assembled or disassembled, the nozzle is then placed in the recess or removed from the receptacle when the nozzle holder is released from the feed line.

In a preferred implementation of the aforementioned embodiment, the nozzle comprises a collar and is held in a form-fitting manner at the nozzle holder by means of the collar. Such a collar provides a simple means of holding the nozzle centered and securely at the nozzle holder, in particular if the nozzle can be inserted into the recess from an inside of the nozzle holder that is hidden by the feed line and the collar then engages behind the nozzle holder. Furthermore, a collar can serve, for example, as a sealing surface and/or for receiving a sealing means.

In a preferred embodiment, the nozzle holder is held at the feed line in a force-fitting manner and, in particular, is clamped in a clip-like manner at the feed line. This enables the nozzle holder to be held securely and quickly releasable. If the nozzle can be inserted into the nozzle from an inside of the nozzle holder, the nozzle inserted in the nozzle holder also allows the nozzle holder to be positioned on the feed line easily and without hindrance.

In one implementation of the aforementioned embodiment, the nozzle holder is designed to be hinged or bend open and can be held in a hinged/bent closed position by means of connecting means and is designed to be clampable on the feed line. The nozzle holder is then also in one piece in a hinged/bent open position and has no parts that can be lost. In addition, positioning the nozzle holder at the feed line is particularly easy when the nozzle holder is hinged/bent open or partially hinged/bent closed, and holding the nozzle holder at the feed line is particularly easy by closing the connecting means. Insofar as the nozzle holder is designed to be able to be hinged/bent open by a sufficient opening angle, it is also possible to position the nozzle holder at the feed line in the radial direction, so that the necessary installation space is kept to a minimum.

In one embodiment, a plurality of nozzles are arranged at the feed line by means of a corresponding plurality of nozzle holders. The teaching of the described solution of the object can then be used for more than one nozzle in the case of a single feed line. In particular, in this case several filter elements can be cleaned simultaneously or a single filter element can be cleaned by means of several nozzles. In this case, different nozzles with different geometries or different flow contours can be used simultaneously.

Furthermore, the nozzle preferably comprises a projection disposed at the inlet opening and projecting into the feed line opening. In this way, a simple and secure centering of the nozzle with respect to the feed line or the inlet opening with respect to the feed line opening is achieved and an alignment of the openings with each other is ensured. Insofar as the inlet opening and the feed line opening are formed round, an additional anti-twist protection is formed, for example, by a corresponding form fit between the nozzle and the nozzle holder.

### BRIEF DESCRIPTION OF THE DRAWINGS

In the following, the invention is explained in more detail with reference to the attached drawings on the basis of preferred embodiments. The term figure is abbreviated in the drawings as Fig.

In the drawings,

FIG. 1a shows a perspective view of a nozzle according to one aspect of the invention according to a first exemplary embodiment;

FIG. 1b shows the nozzle according to FIG. 1a in a side view;

FIG. 1c shows the nozzle according to FIG. 1a and FIG. 1b in a plan view;

FIG. 1d shows the nozzle according to FIG. 1a, FIG. 1b and FIG. 1c in a further perspective view;

FIG. 2a shows a perspective view of a nozzle according to one aspect of the invention according to a second exemplary embodiment;

FIG. 2b shows the nozzle according to FIG. 2a in a side view;

FIG. 2c shows the nozzle according to FIG. 2a and FIG. 2b in a plan view;

FIG. 2d shows the nozzle according to FIG. 2a, FIG. 2b and FIG. 2c in a further perspective view;

FIG. 3 shows a schematic representation of a nozzle assembly according to one aspect of the invention according to one exemplary embodiment;

FIG. 4a shows a side view of a nozzle and a nozzle holder for a nozzle assembly according to FIG. 3;

FIG. 4b shows a perspective view of a nozzle holder according to FIG. 3 or FIG. 4a; and

FIG. 4c shows a perspective view of a nozzle according to FIG. 3 or FIG. 4a.

### DETAILED DESCRIPTION OF THE DRAWINGS

The described exemplary embodiments are merely examples that can be modified and/or supplemented in a variety of ways within the scope of the claims. Each feature described for a particular exemplary embodiment can be used independently or in combination with other features in any other exemplary embodiment. Each feature described for an exemplary embodiment of a particular claim category can also be used in a corresponding manner in an exemplary embodiment of a different claim category.

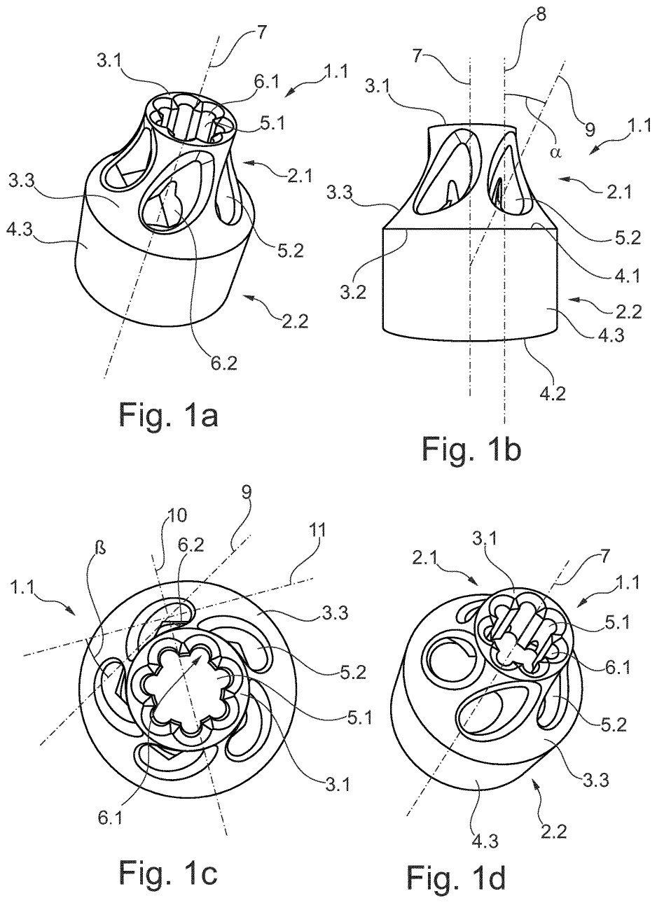

FIGS. 1a to 1d show a first exemplary embodiment of a nozzle 1.1. The nozzle 1.1 comprises a first nozzle section 2.1 and a second nozzle section 2.2. The first nozzle section 2.1 is designed as a hollow truncated cone with a top surface 3.1 and a base surface 3.2 shown hidden. A lateral surface 3.3 of the truncated cone tapers concavely from the base surface 3.2 to the top surface 3.1. The second nozzle section 2.2 is designed as a hollow cylinder and is connected to the base surface 3.2 of the first nozzle section 2.1 with a top surface 4.1 shown hidden. Furthermore, the second nozzle section 2.2 in turn comprises a hidden base surface 4.2 and a lateral surface 4.3.

The nozzle 1.1 comprises a first passage, which forms a first nozzle opening 5.1 in the top surface 3.1 of the first nozzle section 2.1. Furthermore, the nozzle 1.1 comprises five second passages, which are arranged on a circular line around the first passage and form second nozzle openings 5.2 in the lateral surface 3.3. The first passage has a passage axis that extends concentrically with a center axis 7 of the nozzle 1.1. At the first passage, moreover, seven third passages overlapping with the first passage are formed, which form a contour with grooves 6.1 at inner walls of the first passage. The second passages have passage axes 9, which are each arranged tilted with respect to a parallel axis 8 parallel to the center axis 7 of the nozzle 1.1. The passage axes 9 of the second passages are arranged tilted about a first transverse axis 10, which is perpendicular to the parallel axis 8 and intersects the center axis 7 of the nozzle 1.1, by a first tilt angle α. Furthermore, the passage axes 9 of the second passage are each tilted about a second tilt angle β around a second transverse axis 11 perpendicular to the parallel axis 8 and perpendicular to the first transverse axis 10. FIG. 1d shows a view in the alignment of one of the second passages, from which the course of the passage axis 9 of this second opening can be seen in more detail. Furthermore, it can be seen from FIG. 1a that the second passages 5.2 project radially into an inner lateral surface of the second nozzle section 2.2 and form a contour with grooves 6.2 there.

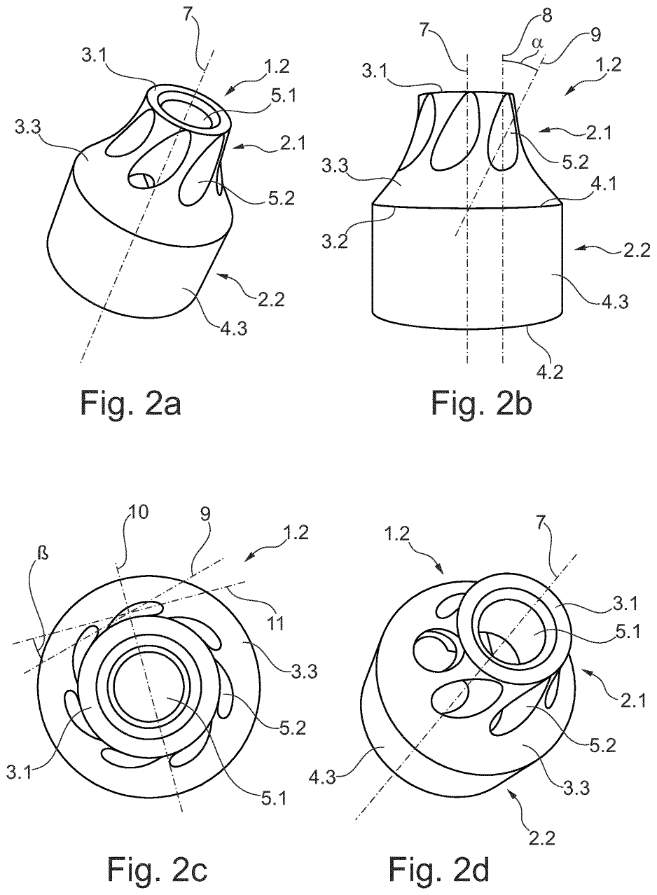

FIGS. 2a to 2d show a second exemplary embodiment of a nozzle 1.2, which corresponds to the nozzle 1.1 in its essential features and differs from the nozzle 1.1 in particular in that it has seven instead of five second passages or second nozzle openings 5.2. Here, the second passages have a smaller cross-section. Furthermore, the nozzle 1.2 is not provided with third passages. The first passage thus has a smooth inner wall. A repetitive description of similar features of the nozzles 1.1 and 1.2 is dispensed with.

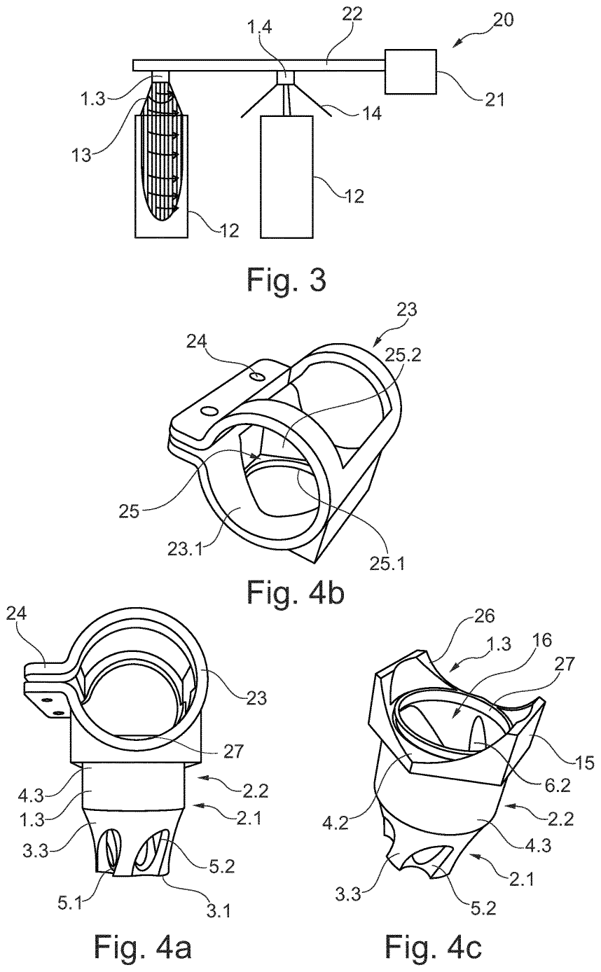

FIG. 3 shows a nozzle assembly 20 in a schematic diagram comprising a pressure tank 21, a feed line 22 connected to the pressure tank 21 and two nozzles 1.3 and 1.4 arranged at the feed line 22. The nozzles 1.3, 1.4 are arranged above cylindrical filter elements 12 and aligned to clean an inner lateral surface of the filter elements 12. The nozzle 1.3 is designed in its essential features corresponding to the nozzles 1.1, 1.2 according to the FIGS. 1a to 2d and therefore has a bundled flow contour 13, the diameter of which essentially corresponds to the inner diameter of the cylindrical filter element 12 and is thus particularly favorably designed for shearing off a filter cake at the inner lateral surface of the filter element 12. In the flow contour 13, the helical shape is represented by corresponding directional arrows. Due to the bundling/constriction of the flow contour 13, the flow contour 13 is designed to be stable over approximately the entire length of the filter element 12. By contrast, nozzle 1.4 is not designed according to the invention, but according to the prior art, and has a flow contour 14 which extends shortly behind the nozzle 1.4 and fans out widely, by means of which a targeted shearing of a filter cake at the inner lateral surface of the filter element 12 is possible only insufficiently or at very high pressures in the pressure tank 21.

FIGS. 4a to 4c show the formation of a nozzle 1.3 held at the feed line 22 by means of a nozzle holder 23, or the nozzle holder 23 and the nozzle 1.3 respectively separated. The nozzle holder 23 is designed as a clamp-shaped component bendable open and can be clamped onto a round feed line 22 by means of a connecting means 24 designed as clamping means. The nozzle holder 23 also comprises a receptacle 25 for the nozzle 1.3, which is formed on the one hand by a round recess 25.1 for inserting the nozzle 1.3 from an inner side of the nozzle holder 23 and on the other hand by a hexagonal recess 25.2 for a form-fitting connection with a collar 15 of the nozzle 1.3. The recess 25.2 and the collar 15 can also have any other geometries respectively corresponding to each other for a form fit.

The nozzle 1.3 comprises the collar 15 with a hexagonal outer contour at the base surface 4.2 for a form fit with the recess 25.2. Here, the collar 15 forms a recess 26 for abutting against the lateral surface of the feed line 22 in such a way that the collar 15 fits into the inner contour 23.1 of the nozzle holder 23 when the nozzle 1.3 is inserted from the inside into the nozzle holder 23. In this case, the nozzle 1.3 further comprises a projection 27 that projects into this inner contour 23.1 of the nozzle holder 23 and surrounds an inlet opening 16 of the nozzle 1.3. As can be seen in FIG. 4a, the projection 27 projects into the nozzle holder 23 and is thus designed to engage in a feed line opening not shown and thus ensure that the inlet opening 16 is aligned with the feed line opening and to center the openings with respect to one another.

Overall, the nozzle 1.3 is held fixed in place and in a torque-proof manner at the nozzle holder 23. In particular, the nozzle 1.3 is held in the recess 25 by the feed line 22 when the nozzle holder 23 is mounted at the feed line 22.

### LIST OF REFERENCE SYMBOLS

1.1 nozzle
1.2 nozzle
1.3 nozzle
1.4 nozzle
2.1 first nozzle section
2.2 second nozzle section
3.1 top surface of first nozzle section
3.2 base surface of first nozzle section
3.3 lateral surface of first nozzle section
4.1 top surface of second nozzle section
4.2 base surface of second nozzle section
4.3 lateral surface of second nozzle section
5.1 first nozzle opening
5.2 second nozzle opening
6.1 groove
6.2 groove
7 center axis of nozzle
8 parallel axis
9 passage axis of second passage
10 first transverse axis
11 second transverse axis
12 filter element
13 flow contour
14 flow contour
15 collar
16 inlet opening
20 nozzle assembly
21 pressure tank
22 feed line
23 nozzle holder
24 connecting means
25 receptacle
25.1 recess of receptacle
25.2 recess of receptacle
26 recess for abutment against the lateral surface of the feed line
27 projection
α first tilt angle
β second tilt angle

1.-18. (canceled)

19. A nozzle for cleaning a filter element by means of a fluid flow, comprising:
a first nozzle section configured as a hollow truncated cone;
a first passage, wherein the first passage forms a first nozzle opening in a top surface of the first nozzle section; and
a plurality of second passages surrounding the first passage, wherein the second passages form second nozzle openings in a lateral surface of the first nozzle section,
wherein the plurality of second passages each comprise a passage axis that is angled with respect to a parallel axis that extends parallel to a center axis of the nozzle, in order to impart a helical flow contour on the fluid flow.

20. The nozzle of claim 19, wherein the second passages are arranged on a circular path concentric with the center axis of the nozzle.

21. The nozzle of claim 19, wherein the first nozzle section comprises a concave tapering lateral surface.

22. The nozzle of claim 19, further comprising:
a second nozzle section, configured as a hollow cylinder, that is connected to a base surface of the first nozzle section.

23. The nozzle of claim 22, wherein the plurality of second passages extend radially outwards from the inside into an outer wall of the second nozzle section to form a contour at an inner side of the outer wall.

24. The nozzle of claim 22, wherein the second nozzle section comprises a collar that defines a recess at a base surface, which recess is configured to abut against a cylindrical contour extending at an angle to the center axis of the nozzle.

25. The nozzle of claim 1, wherein the passage axes of the plurality of second passages are each angled about a first transverse axis, which first transverse axis is perpendicular to the parallel axis and intersects the center axis of the nozzle, by a first tilt angle α, wherein the first tilt angle α is between 0°and 45°.

26. The nozzle of claim 1, wherein the passage axes of the plurality of second passages are each angled about a second transverse axis, which second transverse axis is perpendicular to the parallel axis and perpendicular to the first transverse axis, by a second tilt angle β, wherein the second tilt angle β is 0° to 90°.

27. The nozzle of claim 1, wherein a tapering ratio between an inlet cross section and an outlet cross section of the nozzle is between 1:1 and 3:1.

28. The nozzle of claim 1, wherein
the first passage is round and has a diameter of between 1% and 70% of a nozzle diameter, and/or
the plurality of second passages are each formed round and have a diameter of between 1% and 70% of the nozzle diameter.

29. The nozzle of claim 1, further comprising:
a plurality of third passages that each intersect an inner contour of the first passage and extend parallel to the center axis of the nozzle.

30. A nozzle assembly for cleaning a filter element by means of a fluid flow, comprising:
a tubular feed line having a feed line opening defined in a lateral surface of the feed line;
at least one nozzle designed as a hollow body with a base surface, wherein the nozzle defines an inlet opening in the base surface; and
at least one nozzle holder comprising a receptacle for the nozzle,
wherein the nozzle defines a recess at the base surface for abutment against the lateral surface of the feed line, such that the inlet opening abuts against the feed line and is aligned with the feed line opening, and
wherein the nozzle is releasably held and centered at the receptacle of the nozzle holder and the nozzle holder is releasably held at the feed line.

31. The nozzle assembly of claim 30, wherein the nozzle comprises:
a first nozzle section configured as a hollow truncated cone;
a first passage, wherein the first passage forms a first nozzle opening in a top surface of the first nozzle section; and
a plurality of second passages surrounding the first passage, wherein the second passages form second nozzle openings in a lateral surface of the first nozzle section,
wherein the plurality of second passages each comprise a passage axis that is angled with respect to a parallel axis that extends parallel to a center axis of the nozzle, in order to impart a helical flow contour on the fluid flow.

32. The nozzle assembly of claim 30, wherein the nozzle is held in a form-fitting manner at the nozzle holder and is configured to be inserted into the recess from an inner side of the nozzle holder that is covered by the feed line.

33. The nozzle assembly of claim 32, wherein the nozzle comprises a collar and is held in a form-fitting manner at the nozzle holder by the collar.

34. The nozzle assembly of claim 30, wherein the nozzle holder is held in a force-fitting manner at the feed line and clamped in a clip-like manner at the feed line.

35. The nozzle assembly of claim 34, wherein the nozzle holder is one of hinged or bent open and is configured to be held in a hinged or bent closed position by a connecting means and is configured to be clamped on the feed line.

36. The nozzle assembly of claim 30, wherein the nozzle comprises a projection disposed at the inlet opening and projecting into the feed line opening.
